(19) United States
(12) Patent Application Publication
(10) Pub. No.: US 2013/0110583 A1
(43) Pub. Date: May 2, 2013

(54) MULTIPLE SOCIAL MEDIA NETWORK ANALYSIS FOR USER CONFLATION AND RELATED ADVERTISING METHODS

(71) Applicants: Justin Ormont, Mountain View, CA (US); Jay Zalowitz, Mountain View, CA (US)

(72) Inventors: Justin Ormont, Mountain View, CA (US); Jay Zalowitz, Mountain View, CA (US)

(21) Appl. No.: 13/662,416

(22) Filed: Oct. 27, 2012

Related U.S. Application Data
(60) Provisional application No. 61/552,957, filed on Oct. 28, 2011.

(51) Int. Cl. G06Q 30/02

(52) U.S. Cl. 705/7.29

(57) ABSTRACT

A method is disclosed for analyzing information from social media websites and providing advertisements based on this information. Social media websites are analyzed to determine topics of conversation and, for particular users, areas of interest, levels of expertise, and areas of influence over other users. User information, content, and relationships may be analyzed across different social media websites to match users on different social media websites to a single actual person and thereby obtain additional information about that person. Advertisements may be created which are targeted to a very specific type of user, such as by targeting a particular interest, level of expertise, etc. Users of the social media websites may be qualified according to their interest, expertise, and area of influence and particular users may be chosen for advertisements based on these metrics. Advertisements may be presented to particular qualified users and not to general users.

### PRIORITY

The present application claims the benefit of U.S. Provisional Application Ser. No. 61/552,957, filed Oct. 28, 2011, which is herein incorporated by reference in its entirety.

### THE FIELD OF THE INVENTION

This invention relates to the creation, allocation, placement, or manipulation of advertising using data related to online social interactions between people as well as method for analyzing online social media websites to obtain data about people. This analysis includes but is not limited to analyzing user social connection graphs, friend lists, friend's comments, friends actions, what people share, content of sites people link to, reputation of the sites people link to, content and reputation of sites which have linked to a person, reputation of the other people that interact with a person, and the reputation of the other people that a person interacts with.

### BACKGROUND

Many advertising systems currently in use today do not support important emerging technologies. For example, current advertising systems do not adequately provide advertisements which are targeted to specific people. Accordingly, what is needed is a system and method for analyzing available information related to specific individuals to thereby provide advertisements which are targeted to the person's particular interests, expertise, etc. As will be seen, the invention provides such an approach in an elegant manner.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a block diagram illustrating the flow of data within one embodiment;

FIG. 2 is a schematic block diagram of one embodiment of a social connection graph; and

FIG. 3 is a block diagram of one embodiment of a method for analyzing social media information and providing advertisements.

It will be appreciated that the drawings are illustrative and not limiting of the scope of the invention which is defined by the appended claims. The embodiments show and accomplish various embodiments. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

It will be readily understood that the components of the embodiments, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, a novel approach is provided for analyzing information from social networking and social media websites to determine a person's interests, expertise, etc. This information may then be used to provide advertisements to people who are matched to the person's interests and expertise. In selected embodiments, a computer may be used to analyze information from social media sites. By way of example, the computer may analyze information posted to a social media site to determine a person's areas of interest and expertise. Many different factors such as the nature of the site, depth of information presented, number of persons involved in discussions with the person, etc. to determine areas of interest and expertise. Additionally, the computer may be used to analyze information from multiple social media sites. By way of example, information from multiple different social media sites may be compared to match a person to their profiles or accounts on different social media sites. Information for a person from different social media sites may be combined for a more complete or more accurate analysis of that person's interests, expertise, etc. This may allow a company to deliver advertisements to that person who is specifically tailored to their interests and expertise. This makes the advertisements more valuable as they are more likely to secure a positive response from the person.

Embodiments in accordance with the invention may be embodied as an apparatus, system, device, method, computer program product, or other entity. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of embodiments described herein may be written in any combination of one or more programming languages, including an object-oriented programming language such as Java, Javascript, Smalltalk, C++, or the like and conventional procedural programming languages, such as the “C” programming language or similar programming languages. The program code may execute entirely on a computer such as a web server, partly on a computer, as a stand-alone software package, or on a stand-alone hardware unit or the like. The computer may be connected to other computers or servers such as social media web servers through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Embodiments may be implemented in client side computation applications where certain computations or analysis may be performed on a user's computer in a browser, browser extension or plugin, etc.

The embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

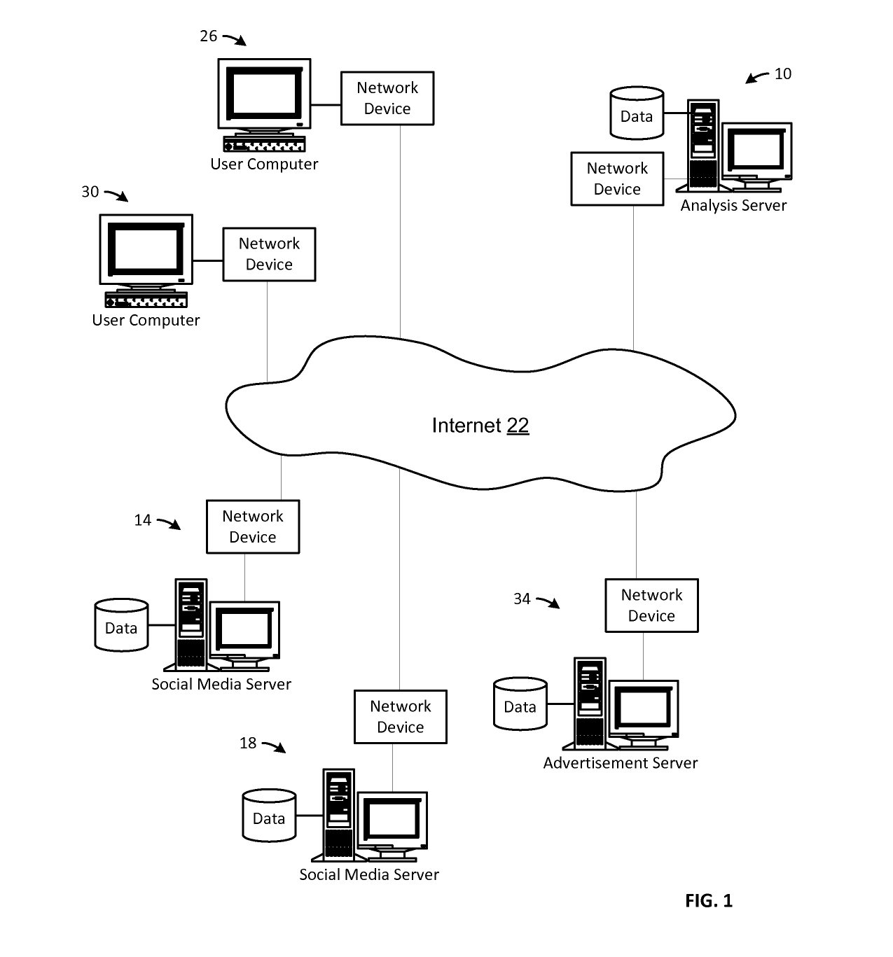

Referring to FIG. 1, an embodiment which illustrates various aspects of a social media advertising system is shown. The system may include a computer such as a social media analysis server 10. The analysis server 10 may perform various tasks such as obtaining information, processing information, etc. The analysis server 10 may communicate with various social media websites 14, 18. The social media websites 14, 18 are represented by computers as the information and computation aspects of the social media websites are often hosted on a computer such as a webserver. The analysis server 10 may communicate with the social media websites 14, 18 via the internet, represented generally at 22.

The social media websites 14, 18 typically communicate with people 26, 30 who are clients or members of these websites. The social media website members 26, 30 are represented by a person and a computer as these people will typically use a computer to access the websites 14, 18 via the internet 22. These people will typically be involved in the exchange of information on the social media websites. For example, these people 26, 30 may participate in discussions, post comments, post pictures, etc. on the social media websites 14, 18. These people 26, 30 will frequently be involved in discussions and in posting information for topics which interest them, which are hobbies for them, or which relate to their employment. These people 26, 30 will thus create a profile within the social media websites 14, 18 which includes many comments, discussions, photographs, etc. in addition to the information which they may enter in a formally created profile. The social media websites 14, 18 may contain significant amounts of information about their members 26, 30 which is present in the form of discussion comments and the like.

Frequently, social media members 26, 30 will each be member of a variety of different social media websites. A single person may be a member of multiple forums, online chat groups, networking groups, and other social groups online. For convenience, these are all referred to collectively in the present application. Frequently, however, a single person will create different identities on different websites. This may be done out of necessity where a preferred user name is taken or unavailable on a social media website. A person may also create a different user name out of personal preference. They may desire to create a user name which is tied to a particular interest and this interest and user name may change for different social media websites.

The analysis server 10 may analyze information from each of the different social medial websites 14, 18 to obtain in-depth information about the various people 26, 30 who are members of those social media websites. Additionally, the analysis server 10 may analyze information from each the social media websites 14, 18 and compare this information to information from the other social media websites 14, 18 to match the various member identities on different social media websites to a single person. This allows the analysis server 10 to accumulate additional information associated with the person and obtain more detailed information about people 26, 30 than could be obtained by analyzing information from a single social media website.

The analysis server 10 may communicate with another advertising computer or server 34, typically via the internet 22. The advertising server 34 may purchase advertising contacts from the analysis server 10. The advertising server 34 typically represents a company which desires to deliver advertising content to targeted people 26, 30. The advertising server 34 may create advertising content which is particularly suited to a particular type of person. The advertising content may be created for a person who has a specific interest, a specific level of expertise in that interest, a particular income level, etc. As such, the advertising server 34 may desire to deliver that advertising content to people 26, 30 who are good matches to the target audience for the advertising content. This may allow the advertising content to achieve a higher conversion rate than an advertisement which is delivered to people without consideration of their interests.

The advertising server 34 may provide the advertising content to the analysis server 10 along with a profile of the target audience for the advertising content. The analysis server 10 may then analyze information from the social media websites 14, 18 to find persons 26, 30 who match the desired advertising content profile and deliver the advertising content to these people. As the advertising content is delivered to a specifically selected audience and is expected to achieve a higher conversion rate, the advertising is more valuable to the advertising server 34 and the analysis server 10 charges a premium rate for the delivered advertisements as compared to advertisements which are delivered without consideration of the people receiving the advertisements.

It is appreciated that in this discussion, objects are used symbolically to represent the companies, people, and other items associate with the object. For example, the servers 10, 34 may be used to represent the companies which own these servers. It is also appreciated that the various objects discussed herein are often used to represent a larger group of objects which collectively perform the task of the representative object. By way of example, the tasks performed by social media website 14 are represented by a computer. These tasks may be performed by several computers or servers forming a larger network or system.

Assigning User Interests and Areas of Expertise

In analyzing information from social media websites 14, 18, it is desirable to extract the topics of conversation in the various discussion threads, comments, postings, etc. One way of doing this with the analysis server 10 is using natural language processing techniques such as analyzing significant words in the conversation. Once a conversation topic is determined, an algorithm could be used to determine what a user is posting or discussing and compare the particular user's comments to the normal level of comments posted by users in general and see if the particular user is beyond the normal level in that discussion topic. In addition, a small sample of the discussion could be extracted and sent to humans for a more thorough review. This analysis may provide indications of a particular user's interests and levels of expertise.

Further, if a secondary user then chooses to re distribute content posted by another user, in some examples this would be called a re-share, the original user's comment is given a higher level of importance in determining the topic of conversation, interests, expertise, etc. and therefore a higher weighting in the cases enumerated within this document. In addition to this the re-shares may be re-shared recursively leading to a larger post amplification factor and therefore a higher score for the original user. In some instances, recency of posts can be taken into account to modify these signals and the signals listed below.

The content of links may assist in determining both a user's interest and expertise in a topic. If a user links to another website, post, etc. it may demonstrate the user's interest in the content of that website or post. In some cases, the general content of a website may be known. Thus, if a user links to a sports website they may be determined to have an interest in sports. Additionally, the content of the website page or post that the user linked to may be analyzed to determine the subject matter of that page or post, and the user may be determined to have an interest in that specific content. Additionally, the presence of other websites or other people or profiles linking to a user's posts or profile may indicate an interest or expertise. If a sports website, for example, links to a user's posts or profile the user may be determined to have an interest in sports. Additionally, a user may be determined to have a degree of expertise in a topic or interest if other people or websites link to their profile or posts. The reputation of that linking person or website may influence the degree of expertise assigned to the user.

In addition to determining the content of a user's post, it is also important to use what the content of the reaction to the user's posts is. If the user has influence or over topics or expertise, people would generally reply back to in their topics. The more that there are replies back from humans, the more that the author generally has influence over that topic. In one example, a user could post that they like “cats”, and the replies back would be about the weather, in that example that would not indicate expertise, whereas if the reply was about “Siamese cats” it would be a signal of expertise.

Other forms of feedback include but are not limited to social gestures such as likes, mentions, +1s, etc. These types of feedback could be used as a modifier to the original comment or social action to give a signal regarding the user's level of expertise regarding the original comment or action. Additionally, the user's reputation, job, and expertise among other topics could modify the signal for a particular comment. If a user has connections to people who have interests in a given area, that user will generally have higher influence on that area. This could also apply to the sub sets of expertise. In one example, a user with expertise over “Siamese cats” may also have expertise over “tabby cats”. Another example would be a hierarchical use, where someone having influence over “Siamese cats” is also more likely to have influence over the entire category of “cats”, additionally the reverse, where someone has influence over the category of “cats” can be determined to have influence over “Siamese cats”.

Extrapolating that example further this could be used in principal in relation to things that are related in nonhierarchical and hierarchical ways. Thus, a car and a truck can be related to each other in various ways including that they are both vehicles, or they are both objects that have headlights. In one example this could be used in the case of a general graph of ideas as opposed to a strict hierarchy, or it could also be used in the case of relations of knowledge. These various analysis techniques may be used by the analysis server 10 to analyze information posted on a social media website by a user and determine what areas of interest and expertise that user has and how this user compares to other users with similar interests.

Any time that there is a connection between nouns, verbs, adjectives, ideas, concepts, or objects, a person's high interest or expertise in one area may spreads or be associated with to other connected nodes, such as other topics or interests. Continuing this idea, having a level of expertise gives a greater than zero probability of a user being an expert on many additional topics. A probability threshold can then be set to determine expertise in a topic.

If there is a direct mention of an area of expertise with respect to a user's profile, it would be possible to assign a strong indicator of expertise in this area to the user. For example, where a group of users has the group title which can be determined to be photographers, the users in that group may be assigned expertise in photography. In this example, the level of expertise would be made even stronger if other users then re distributed information related to the group in any way thereby showing their approval of the title. If a business profile within a social network chooses to re-share the statements of a user and that user was acting in some way shape or form within the topical area of a business it could in one example be given a higher weighting as to a determinant of expertise. Additional information would possibly be gleaned by looking at the reputation of outbound and inbound linking, for example if a newspaper such as the wall street journal were to make a reference on their website to your social action, it could be a sign that you are either a well-known authority on a matter, or are very correct in what you are saying, among other things.

Further, additional information such as expertise or interests could be determined from elements in a user's profile such as their listed company, occupation, work title, job description, etc. For example, if a person were to list “Google” as their current employer, they might be assumed to have a higher level of influence or knowledge in programming, Silicon Valley, organic food, or workplace benefits. They may also be assumed to have a higher than average expertise for other things such as android phone use, and the topic of the company “Google” itself. Likewise, if a person were to list their job title as “particle physicist” they could be assumed to have a higher influence or knowledge as to high energy physics. In addition if that user listed that their workplace was well known company such as “CERN” they would get a higher “reputation” in that subject based upon “reputation” of the company.

Conversely, if a user were to list their employer as Google but listed their job description as a cook or their job title as head chef, then they would get a lower weighting towards topics such as programming or electronics, as their job function would not indicate their expertise on the subject as strongly. In some examples this could be strong enough of a dislocation as to be lowering to the expertise probability.

Cities, for example, can be used to determine expertise as well. For example, if a person lists that they live, or have lived in a city during any time period it would be possible to determine information from this. In one instance, a user could state that they lived in San Francisco, and the user would therefore be presumed to know more about the nightlife of San Francisco, the tourist attractions in the area such as Alcatraz, or restaurants in the area.

These correlations between terms can be found in multiple ways. These include but are not limited to, internal sources with a network. For instance we found that many Google employees are knowledgeable within the subject of programming, Silicon Valley, and organic foods. Another method would be using external sources such as analyzing or spidering relevant webpages about the company and determining higher percentage likelihood details about the company. For example the Wikipedia page for Google contains information confirming that the employees typically do programming and get free organic food. It is also possible to determine factual associations like the fact that Google is located in Silicon Valley.

Assigning “Value” to a User

Assigning a relative value for interests or expertise to a user could be done via a combination of values generated by many techniques. In one example you could take a weighted sum of the “per” topic score/influence. One effect of this scoring method is that the more topics that person has influence over, the higher their total score. Thus, if a person has a large amount of influence in a singular subject they would have a lower score than someone with somewhat smaller influence in more subjects. One downside to this method is that there is no maximum score and as such the score may have to be normalized later. One possible method for normalizing this information is by taking the log of a particular user's sum score over the log of the maximum sum score for many users or the whole group of users. This helps the non-extreme cases (users of ordinary levels of expertise) still have highly relevant scores while still recognizing the extreme case (extreme experts in an area) by placing them above users with lower sums. In this example you might add to all users scores across the board in order to ensure that there no scores below zero. This can be accomplished by adding 1 to the user's previous scores.

According to this example, a normalized score may be calculated by the following equation:

Normalized score=log(1+X)/log(1+Y)

In the above equation, X is the user's score for a topic and Y is the highest score for that topic among all users, representing the most knowledgeable or the most influential user for a particular topic. The above equation results in a maximum normalized score of 1 and a minimum normalized score of 0.

This equation could be used to value connections in the social graph (i.e. a number of friends, links, or connections on a social media site) by determining a base value using the formula above of each user where x is the total number of connection a user has and Y for example could be the most connected/followed example. The same algorithm could be used to modify the score for some weighted or unweighted accounting of normal, average, or peak users, recursing a few times down and using a dampener in a similar method to what is described in the page rank algorithm.

There are many ways to compute a global score or a total score. A global score could also be calculated by summing the user's expertise over all topics. Another possible method of determining a score would be to take the top 5 or the top N topics of their knowledge base or influence areas and taking the average of those 5 or N scores. This has the benefit of being self-normalizing for a score. However, it is optimized for people who discuss exactly 5 (or N) distinguishable “topics.” If a person discusses only one topic it will serve to the detriment of that users score as their one topic's “score” will be effectively divided by 5. If a person discusses many topics, for example a true generalist would also have a lower composite score due to the average of five already low scores (since they would not likely be viewed an expert in any topic without significant focus on any particular topic).

Another method would be to simply take their highest topical score, however this has the benefit of assisting people who are only experts in one topic area, and this conversely provides an even poorer score for someone who is a generalist.

Site Analytics Style Display of Social Information

In some examples this could display social information, in other examples things like job title viewership on certain page, or influenced based averages. Ideally, the analytics could offer not only a view to the buyers of ads, but also a combinations social view of information to those who control the social media website. This could possibly provide a benefit to zone in on the behavior of certain classifications of users.

The systems and methods described herein are adapted to consider a wide variety of available information and relationships. As discussed, conversations, discussions, posts, etc. may be analyzed according to topics and keywords, relevance of posts, reposting, nature of content, etc. to determine what the topics of the social media are and how the various users rank in expertise and interest for a particular topic. These scores of interest and expertise may be normalized or weighted in different manners to prevent too large of a discrepancy between different users or to otherwise make the information more usable.

The global nature of the method allows a range of metrics to be used and displayed to buyers of ads, website owners, or others. For a given topic, a sub-set of the metrics may be more relevant. This more relevant sub-set can be emphasized in the method and analytics display. For example, during the course of an advertising campaign a particular group of influential users may be targeted based on their influence over a larger target group. This group of influential users may be selected using a first set of metrics. As the advertising campaign continues, the metrics and groups may be redefined to follow the more successful initial results. The systems and methods described herein may provide feedback to the advertiser about user responses, the characteristics of the user's responses, and which metrics are most relevant. This allows the advertiser to fine tune the campaign and more efficiently utilize social network information.

Determining User Identity

In addition to analyzing the content of a user's interaction on a social media website, the analysis server 10 may analyze information from multiple different social media websites in order to match a single person to multiple different user profiles on different social media websites. Although we will be using examples of just two social networks for simplicity, all concepts discussed below can be applied to a situation considering more than two content or social networks. In some instances, this is referred to simply as matching a user (i.e. a user profile) to a person (i.e. the person who created that profile. This may also be referred to simply as matching a user. In many cases, it may not be critical to match a user profile to a specific person. In many cases, it may be important to simply match multiple different user profiles on one or more social media websites to a single person, even if the precise identify of that person is now known, as matching the different user profiles together will provide additional desired information about the person who created the user profiles. This concept of user matching across different user profiles may also be referred to as conflation. Conflation occurs when the identities of two or more user profiles, share some characteristics of one another and seem to be a single identity.

Determining User Identity with Social Information—within User Profiles

User profiles may be matched together in many ways. It will be appreciated that a single data match between profiles will rarely provide conclusive evidence that these profiles match (i.e. match a single person). Typically, multiple data matches are found until the cumulative probability of a match is sufficient for the precision required of the particular application or use of the data. In matching profiles, matching data such as name similarities, workplace, school, job description, location or residence, marital status, interests email address, user name are discovered or analyzed. User profiles or user posted content on one website or multiple different social media websites (sometimes referred to as networks) are analyzed to discover these matches and determine a likelihood that the profiles match a single person.

One possible way of determining the identity of a user is by matching image or video posted by that user; possibly as part of an original image or video, or a modified version of an image or video. The URL, name, or metadata may be matched. The photo may be analyzed to determine if it is the same photo with simple modifications such as cropping, sizing, or filtering. In another example, a user's identity may be determined by using facial recognition techniques to give a probability that user is the same person as a user on another social media website. User profiles or accounts from different social media websites may be matched as belonging to the same person by name and possibly in conjunction with the social actions that user takes. These social actions may be expressing an opinion about a particular person or brand, commonly discussing topics, determining locations of images taken at a given time, possibly by examining items in the background, gaining a fingerprint of those objects or by using the meta data of the images, including but not limited to the make and model of camera, the GPS locations, or the serial of said images.

Another possible way to match profiles on different social media sites includes cross-referencing information along with the time of that information being added to the websites, such as when the information is listed in their profile. This information may include things like being in a particular location, interests, relationship status, date of birth, a cross social network posting of extremely similar content, posting of similar content as determined by the context, mutation, and feature availability of the content or the social media network. This information may also include similar behavior and posting habits such as similar posting times and topics, or similar reactions to events. This information may also include home city, place of residence, profile biography, etc.

Another example of matching metadata would be checking for a user adding a relationship status such as marriage at the same space in time, or within relatively short succession on different social networks. Another example of matching users between networks based upon user generated content would include taking a sample of voices between two separate audio or video files. Another example would be bidirectional links between profiles. If profile A in network 1 links to profile B network 2 and profile B2 also links to profile A1 the case would be made even stronger. In addition to this, if for example a rel=me anchor tag exists within a profile directly specifying that another profile is the pair to the social account that could potentially be taken as a very strong signal.

One of the strongest signals could for example be a temporal based association of updates. For a simple example, a user could state that they have moved to city B from city A on their profiles in both network C and D, indicating that the user on network C and the user on network D are likely the same person. In another example, a location based social network could start showing a person at restaurants and shops on another side of the country whereas a profile on another social network indicates a move to a new city where the shops and restaurants are located. This indicates that the two different social network profiles belong to the same person.

It will be appreciated that a single association may not provide sufficient confidence to determine that a profile on social network A and a profile on social network B belong to the same person. Multiple of these updates and associations between the social media networks may be used together to provide a desired level of confidence that a match has been found.

Determining User Identity with Social Information—Via Looking at the Graph of the Users Connections

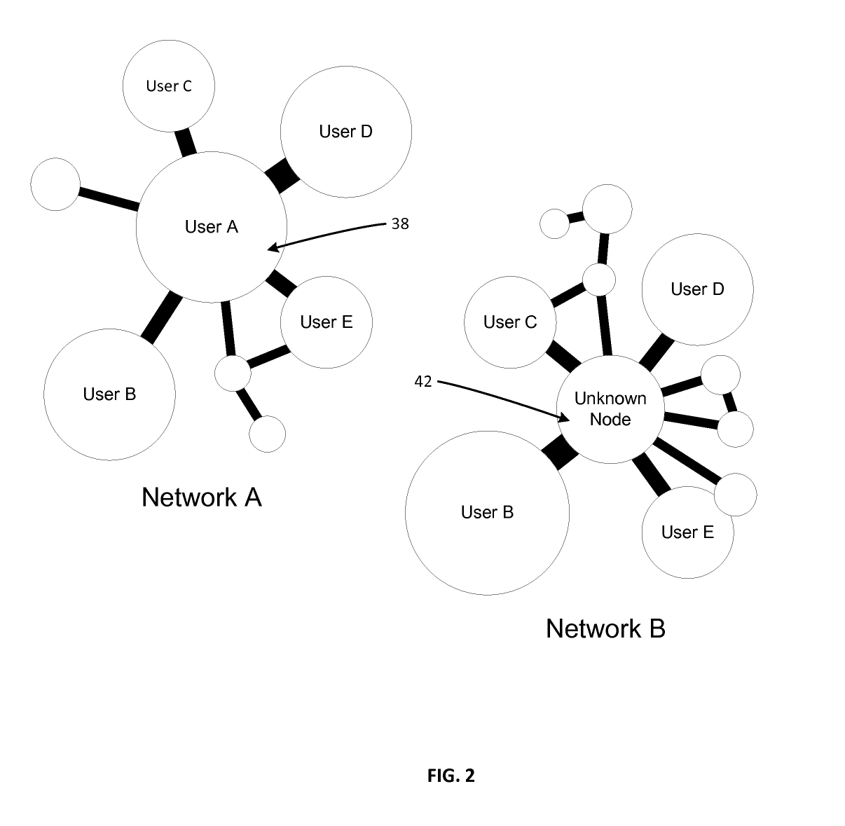

Social graphs, charts showing the relationship connections between various users of social media websites, may also be analyzed to match users of different social media networks as being the same person. These graphs may also be analyzed to determine missing information about a particular user. FIG. 2 illustrates two social graphs which can be determined to likely be for the same person due to the overlapping via the connections (or edges) that they have. In addition to this, missing nodes (people) within one of the social graphs could be filled in using the information from the other network. For instance, looking at two social graphs of FIG. 2, you could determine that user A, indicated at 38, and the unknown user indicated at node 42 are likely the same person as they have the same social network.

In one example, a user may participate in two or more social networks. On a first social network, information about the user's identity and connections with other individuals are known. This formation can be used to create a “connection graph” that can be compared to similarly created connection graphs on other social networks. This may allow the user's interactions in a second social network to be identified, even if the user's identity is not publicly available on the second network. Thus, the techniques described above can link a single user across multiple pseudonyms and social networking platforms to accurately identify the user, the user's interests, measure the user's influence, and determine the extent of the user's network.

In creating and analyzing the connection graphs for various users, different nodes are created corresponding to different users on the social networks. Connections between these users, or edges, are created to show the links between the users. These edges may be determined by analyzing the user profiles and posted content. The edges between nodes may be weighted or categorized by type to assist in analyzing the connection graph. Edges may be weighted according to factors such as the number of interactions between two users. Edges may be categorized according to known information. As an example, a known relationship between users such as marriage or another family relationship may allow the edge to be designated as a particular type or connection. The weight or type of edge may be used to assist in matching two connection graphs to each other and thereby matching two different user profiles to the same person.

Information regarding the various social graphs may be utilized among the members of the social graphs. By way of example, users who are present as a node on one social graph but not present on another social graph from a social media website may be invited to join that social media website. They may be presented with information regarding their friends who are already members of that social media website. Thus, where User 1 does not exist on network A but we can determine how User 1 would fit in to Network A based on finding User 1 on a social graph created from Network B and/or noting that User 1's friends on Network B exist on Network A. User 1 may then be invited to joint Network A based on the information regarding the relationships they already have with people on Network A. User 1 may be placed on Network A with the corresponding relationships that is known from Network B. A single unified view of multiple social networks combined in to a single super graph of social relationships. The strength of all the relationships can be tracked across networks and merged when creating the unified social graph.

As you can see in FIG. 2, the graphs for this user and their connecting nodes are very similar among the two social media networks. Using this insight, comparing nodes as if they have a possibility of being the same object that appeared in the other graph is possible. Using this method could help determine if an unknown entity is the same as another entity in another social graph. An unknown node in social network A has a non-zero probability of being the same user as every other node in social network B. For every node in social network A there is a nonzero probability of matching every other node in social network B, in this example there would be a larger probability of matching the correct node of the matching person in the corresponding graph.

Based upon the similarities in social network layout mentioned previously, in this example we could further improve the likelihood of a match via the combination of the two separate indicators of similarity. In addition to this, it is possible to determine that user A is likely to connect with a particular person because of user C, or that user A and user B are likely to interact with each other in relation to user C.

Another example of matching friends graphs from different social media networks would be comparing the shape or structure of the graph in order to determine probability of similarity with respect to the person placed in that node. In this example it can be determined that social network A has a similar structure of connections to social network B without necessarily looking at the content of the nodes. This could be possibly used to determine an increased possibility of matching users represented on these social connection graphs as being the same person. Information such as the time of the creation of a connection between users or the dates of first interaction between the two users may be used to assist in matching users between the different social connection graphs and thus between the different social media networks.

One example of an algorithm to determine edges and node correlation would be to take the nodes or edges that have an extremely high probability of being the same and using those as the start point in determining if another node is the expected node. Once that node is determined in this example the algorithm would then iterate further into the graph while still being constrained by the node match probability and edge match probability. This can be described as a “greedy” graph matching algorithm. There are more other algorithms than this, some of which are more accurate. For instance, a more global based algorithm to find the optimal or near optimal map between the social networks may be used. In addition to this, taking into account that some users will not exist in both social networks could yield an improvement.

Another way of matching users between different social connection graphs would involve using a user's common connection type. For example, a person could generally link primarily on in a large measure to CEOs of fortune 500 companies. This would be an example of behavior based linking. Another example would be a user who only links to user groups A and B, within geographical area A, or within social area A. For example within Madison, Wis. along with people in San Francisco. These users do not have to be the same people. In this example only the fact that similar connections related to geographical locations occurs is important. This connection could be further enhanced by looking at the time these connections first occurred to more conclusively match users to a single person. For example, determining a matching time when a user has an internship or travels, matching users to a single person is likely to occur.

The techniques for establishing a user's influence can account for a wide variety of variables, such as whether in a particular network the user is a leader who actively produces content and interaction or if the user is a more passive follower who typically consumes or reposts content. This asymmetric relationship can be positively captured and described in metrics such as a user's influence score on a particular topic.

These methods of matching different user profiles on different social networks to a single person assist in assigning more accurate areas of interest, spheres of influence, and levels of expertise to a person. In evaluating across multiple social media platforms, it may be determined that a person has a large area of influence over other people and thus that person may be a more valuable advertising target as their acceptance of a product may influence a large number of other people. Similarly, it may be determined that a person has a higher degree of interest or expertise relative to a particular topic and that person may thus be a more valuable advertising contact as the person may be more likely to accept a product related to their interest, and their acceptance would likely influence more people due to their expertise.

There are a variety of additional uses of this combined information obtained by analyzing different user profiles and matching multiple user profiles to a single person. For example, if one wanted to infer that a new/different user profile on a different social media network existed or was owned by a known user without direct knowledge of it, one could analyze the identified activities of a known social network and recognized input from outside networks. An example of this would be a foursquare checkin which has been shared to facebook. In this example, despite the user never signing in with foursquare, the facebook profile information allows us to join in all of the users identified foursquare checkins and consider those as part of the actions that that user has taken. This also allows for considering that person to own that foursquare profile and, whenever new data is added to associate it with the user.

Another use of the information obtainable from matching users from different social media websites to a single individual would be in combining information together. This may be desirable in compiling information about a person for advertising purposes, background research, applications or forms, etc. For example, users currently using social media network A and using social media network B may have different behaviors on the different sites. For example, there may be limited birthday information on social media network A due to people being more private. A user may be more apt to use this information on social media network B, however. Thus, information from social media network A could be joined with the information from social media network B to add the birthday information from social media network B with the additional information from social media network A. Credit checks could be used to provide additional information about a person that assists in linking a person to one or more social media user profiles/accounts. It is appreciated that certain social media websites (such as friend networks) are more likely to contain behavioral information while other social media websites (such as professional networks) are more likely to contain biographical information. Certain social media websites such as forums are more likely to contain information about hobbies and interests while social media websites such as blogs may be more likely to contain ideological information.

Serving Advertisements, Offers, Media, and Information Based Upon Social Information

Determining the relative placement of a human being in the social context is applicable in numerous circumstances, including and not limited to, determining the relative value of serving an advertisement, offer, or thing of any context to that person at any given time. One example of this would be an occurrence within a social experience; however, this can also be applied within the outside web as a whole, down to real world applications such as in store, or street level communication with consumers. In some examples of this type of advertisement, information from multiple social networks could be combined to better determine what a user would want or what a user may be able to influence others to want.

A possible example of this would be an advertisement network that offers more value to a website (either internal or external to the social network) in, for example an auction based system, to advertise to a user who not only has been determined via many things to want the product or relate to the product, but also has been determined to have influence and expertise when speaking about the product. In some instances this could include combining the serving of an advertisement to a selected user on a website in conjunction with serving a deal that the user could extend to additional other users such as the user's connection graph or the general population that the user could influence.

In another example, a user could be offered a larger variable discount on an item based upon influence and amplification among other users. One potential side effect of doing this is that the company may forgo profit with that user in order to receive an order of magnitude larger profit from sales that that user influences or connects to. For example, the user's influence can be measured based on the interests of others in their networks. A user may be part of a network that collaborates based on Italian gourmet cooking. However, if a large number of other people within this network have strong interests in cars, the user may have a large amount of influence over these people even in the user does not have particular interest in cars. An automobile dealership may offer the user a free weeklong test drive of a particular automobile based on the user's ability to reach a large target audience of people who have strong interests in cars. The user can then spontaneously share their experience with the automobile in a trusted network and reach a large number of automobile enthusiasts.

One possible embodiment involves using a method of valuing delivery of advertisements to individuals in relation to their relative odds of amplification of the advertising. The end goal of this would be a higher overall return on investment to the marketer. One success factor of this would be CPPM, or the cost per perceived thousand impressions.

Another possible way of valuing the adverting to a user would be to look at the preferences of other users and further determining that the user is more likely to acquire/purchase/etc. what is for sale in the advertisement. This would result in charging a slightly higher cost for the advertisement impressions due to correct targeting. Social media website users may be targeted through some of the techniques used above in relation to the user that the advertisement inventory would connect with.

Another possible modifier to the advertisement network would be directly targeting ads to outside websites using social data. For example, an advertisement could be created which could only be seen by 20-30 year old people that worked for Google if desired.

There are several possible ways to serve the ads to customers, which include but are not limited to the following process. Initially a user may sign on to or sign up for a service, website, etc. When that user uses an authentication method such as OAuth, that authentication method gives them the ability to sign into a website with an account that belongs to a social media service. In many instances this would come with a dialogue box that asks the user if they are willing to share information with the website.

When the website makes its first connection with the user's social media account it may receive a “key” for that user's data on the social media account. This key could be stored in a database for “instantaneous” or on demand access of the social media system data. Alternatively, upon registration of the user, the entity using the advertising service could “curl”/“post”/etc. a key to the analysis server along with a unique identifier for them. By way of example, the analysis server could store a pair key for that user where the key would be the site unique id and user unique id. This way of presenting the data would conform better with the social networks services/terms, as all social media data could be restricted to use within the medium to gain the social information (such as the analysis server), allowing ownership of the social media information to stay intact. We would then in this example proceed to optimize of the “advertisement” based upon the social data the user gave to the site among other things we can infer from an analysis of the user's social media as discussed above.

Upon a user entering (logging into) a website, the analysis server 10 could implement a market based system for the advertisement space on that website to determine what ads will be served to the user. This determination may be made based off of an analysis of the user's social media information as discussed herein. This determination may include relevancy to the website content, user benefit of seeing the advertisement, amplification ability of the ad, user expertise, the user's job, etc. and these items could be used to adjust the price of the advertisement (CPM/CPC/etc.). When an advertiser is trying to enter this system, they can specify many different variables to “zone in” on their target audience. The analysis server could use that information and data from user interactions to further fine tune the advertisement placement and expand the advertisement to other relevant places. In addition to this we could potentially do a “group buying” mechanism within this system as the social aspect is already there.

The social media analysis and advertising system may learn from user activity as it relates to advertising activity. Where the analysis server is working with the framework of a website serving an advertisement to a social network authenticated user, the analysis server may take into account things such as: users influence, graph size, velocity, graph density, graph amounts, true reach, propensity to click ads, income, sex, age, weight, height, photo context, tagging likelihood, amount of other people who are experts or have influence in the topic, relative amount of influence, relative expertise, graph expertise, graph influence, graph velocity, graph photo context, graph location, user location, graph true reach, graph average income, graph peak income, graph standard distribution of income, graph age, graph average age, graph age clustering density locations, likelihood of person posting about product, searches performed by a user and/or a user's followers, and other factors. Additionally, associations between different searches performed by the user may provide increased information about user interests. For example, if user A searches for user B then afterwards user A searches for “cars”, the score for the topic of “cars” may increase for user B, and for user A. It may increase for user B since it is correlated with a search for information about user B. It may increase for user A since the user is interested, wants to know more about, or has some other relationship with “cars”.

In the example case of market bidding, such as a company trying to place a MPU on a webpage, the analysis server 10 may take into account things such as: average click through from users on advertisement, group limiting targeting requests, targeted group size, targeted group advertiser demand, the “perceived quality” of ads, which would in some instances be determined by input from users, demand on impressions per user, and current market impression required per user on that user.

The cost of showing an advertisement to a user or a group of users generally increases when there is more demand to that user or group of users, conversely when there are very few ads to be shown to a user or group of users the price of the advertisement generally will go down. In the present system we could charge more for more specific groups of users when the criteria for displaying the advertisement is more narrowed as that places a higher demand on the remaining population of the audience of the “site” for example if 1000 advertisement impressions need to be served to unique users and there are only 1500 unique users in the “user population” than the demand on that group of users is much higher as ads are required to be displayed 66.6% of the total user population for that ad, another way of saying this, is that there are 0.67 required impressions per user, which would be the demand per user, this can be contrasted with when the population of possible targets is twice as big, the demanded impressions per user would be only 0.33 p/u. As an advertising company limits the total audience, in this example model of advertisement pricing, the price per advertising or the cost per impression or CPM will be increased.

In many instances, advertising can not only be targeted to a particular audience but can be delivered to the audience in a way that is particularly likely to impact them. For example, if an influential user accesses and posts on a given site after work each day, an advertisement could be delivered to that site at the time that the user is most likely to see it and be posting/blogging about a topic related to the advertisement.

There are many considerations to take into account in choosing which ads to serve to a given user. The system should take into account a maximization function of total profit, both for the company as well as the clients over time. Generally, it is desirable to serve the ads that make the most on a per user basis in order to maximize the profits on the side of the analysis server 10. There are optimizations that can be made in order to maximize the total revenue or profit over the global system. In some instances, a large bid for advertising in one area of the market could push much more bid inventory on to the larger portions of the market. Over time this may throw the system off balance and causing a sub optimal bid flow. This may lose money over time due to issues like the “tragedy of the commons.”

An example of a locally optimized solution would be a greedy algorithm that simply serves an advertisement to the “user” with the highest influence in the subject that the advertisement relates to. One downside to this is that the user may be suitable for many different ads and that user is now taken out of contention for the other ads. Since there may have been other users that were near optimal for this particular advertisement, it may have been a much better fit for the global optimum to deliver this particular advertisement to another user and deliver another advertisement to this particular user.

As a simplified example, a two person sized market with only one criteria there could be a cat ranking of 0.9 on user A and a cat ranking of 0.7 on user B. User A also has a dog ranking of 0.8 and there is a near zero ranking for user B on dogs. If there are advertising needs to fill for both dog and cat advertisements, a greedy algorithm would award user A a cat advertisement and no advertisement to user B. In this greedy algorithm, there would be no suitable match for the dog advertisement. In a globally optimized solution it would be desirable to pick user B for the cat advertisement and user A for the dog advertisement even though user b has a lower cat ranking. This global optimization would be desirable for both advertisements as it would place both advertisements with suitable users.

As used in the specification and appended claims the term “social connection” refers to any relationship that links two users. For example, social connections include friends, followers, circles, or other relationships.

The preceding description has been presented only to illustrate and describe examples of the principles described. This description is not intended to be exhaustive or to limit these principles to any precise form disclosed. Many modifications and variations are possible in light of the above teaching. For example, although the description above specifically describes scenarios where social information and interrelationships are used for advertising, the techniques can be used for a wide variety of other applications. In one implementation, the social analysis techniques may be used by a politician to determine which people in their contingency have a large amount of influence over other people or which people are undecided about a particular topic. The politician can then take appropriate action, such as making personal calls to people with large influence scores or targeting undecided voters with more information about a relevant topic determined from social analysis. In other applications, law enforcement officials may desire to obtain more concrete information about a person, a network, or an event. The social network analysis techniques described above could be used to more positively identify a person, their amount of influence, their contributions (anonymous or otherwise), and their followers.

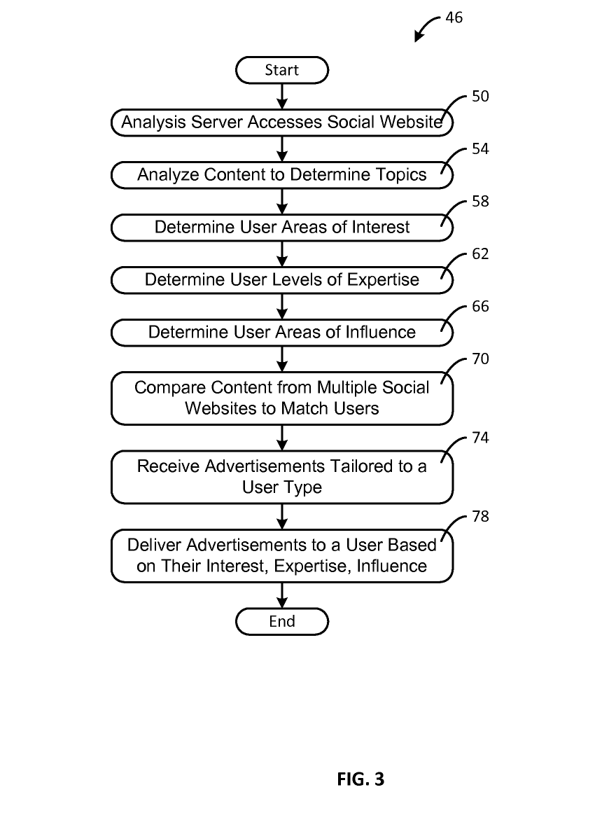

FIG. 3 generally illustrates a process 46 which may be used to analyze social media and provide advertisements. An analysis server 10 may access 50 a social media website. The social media website may be of a variety of types, including forums, blogs, networking sites, social feed sites, friendship sites, etc. The analysis server 10 may analyze content of the social media website to identify various topics of conversations/postings 54 on the website. This may provide the analysis server 10 with information regarding the content of the site and may provide information as well as a background to use in analyzing individual users of the social media website.

The analysis server 10 may then proceed to analyze the website content to discover areas of interest 58 for the various users of the website. The analysis website 10 may review the relationship of a user's posts or contributions to the topics of posts or conversations to determine the user's interests. The analysis server may analyze additional information such as user profiles to determine user areas of interest. The analysis server may also then analyze website content to determine levels of expertise 62 for the website users. The levels of expertise are related to particular areas of interest for individual users. The analysis server may review a user's posts or contributions in relationship to a larger conversation or topic as well as comparing the response of other users' response to the user posts to determine what level of expertise the particular user has for a topic. The analysis server may assign a level of expertise for each topic or area of interest that is associated with a user. The levels of expertise may be normalized, such as by comparing the log of a user's expertise raw score to the log of the highest user's raw score in that same area.

The analysis server 10 may also analyze areas of influence for users of the social media website. The analysis server may determine how many friends or connections a user has or may analyze how many responses, reposts, etc. a user receives for posted comments or information. The analysis server may analyze the number of views, likes, etc. that a user receives for posted information. This information may be used to determine how many other users are influenced by the particular user's posts or contributions to the social media website.

The analysis server may also compare 70 content from different social media websites to find user matches. The analysis server may analyze different types of information such as friend connections, commonly posted information, common status updates, common life changes, etc. and may use this information to determine if profiles on different social media websites belong to the same actual person. When matches are found, additional information may be obtained about the users. The social media website may be analyzed as discussed to determine additional information about the user. The combined information may yield additional information about the user's interests, expertise, area of influence, etc. By way of example, one website may provide a user's job or stated hobby while another website may provide the user's posts on these topics as well as other users' level of response to the posts. The combined information may provide a more accurate picture about the level of expertise that the person has, for example; more accurately indicating the user's degree of expertise in their field of work.

The analysis server 10 may receive advertisements from an advertising server 34. It is appreciated that the analysis server 10 is often used herein to symbolically represent a company engaged in analyzing social information and delivering advertisement (often utilizing a server to perform analysis) and that an advertising server 34 is often used to symbolically represent a company which desires to provide advertise content to users, such as advertising their own product. The advertising server 34 may create advertisements and these may be received by the analysis server 10. The advertisements are frequently not a simple presentation of goods or services similar to conventional advertisements.

The advertisements are often tailored to a particular type of person, and may be tailored to a particular interest as well as a particular level of expertise or sophistication in that interest or even to a person with a particular amount of influence over other persons through the social media websites. These advertisements may often provide an incentive to that person which is much greater than a typical coupon or discount. The advertisements may provide a free product or an extended trial of a product to familiarize a user with that product. The advertisement may also request that the targeted user perform certain actions in exchange for that incentive, such as communicating a review of the product to a social media website.

The analysis server 10 may then deliver a targeted advertisement to one or more users on a social media website. The analysis server 10 may select a particular user based on their interests, expertise, or area of influence and may qualify a user as being a match to the intended audience of the advertisement. The advertisement may be presented only to that user when the user logs on to a social media website and not be presented generally to all users visiting the social media website. The advertisement may thus be delivered to relatively few users compared to common online advertisements which are delivered to all visitors of a website regardless of any particular qualification of the user. By providing an advertisement which is created for a very particular type of user, qualifying users according to analyzed social media information, and presenting the advertisement only to qualified users, highly valuable advertising may be achieved. The advertising is valuable to an advertising server 34 as it is expected to achieve a high response rate. The advertising is lucrative to the analysis server 10 as the charge for presenting an advertisement is correlated to the success of the advertisement.

The various modules and parts of the social media analysis and advertising system may include both hardware, firmware and software components as are desirable for various embodiments and to achieve the various steps, features, and functionality discussed herein. The flowchart and diagrams of the Figures illustrate the architecture, functionality, and operation of possible implementations of systems, methods, and computer program products according to one or more embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for matching different social media user profiles to a single individual comprising:
accessing a first social media website with a computer;
analyzing data associated with a first user profile from the first social media website;
analyzing data associated with a second user profile from a second social media website, the second user profile being different from the first user profile; and
matching the first user profile and the second user profile to a single person.

2. The method of claim 1, further comprising:
comparing connections between the first user profile and other users on the first social media website
comparing connections between the second user profile and other users on the second social media website; and
identifying common connections associated with both the first user profile and the second user profile.

3. The method of claim 1, further comprising identifying common relationship data for the first user profile and the second user profile.

4. The method of claim 1, further comprising identifying common posted information associated with the first user profile and the second user profile.

5. The method of claim 1, further comprising identifying common biographical information associated with the first user profile and the second user profile.

6. The method of claim 1, wherein the method comprises matching a first user from a first social website selected from the group consisting of networking sites, media sharing sites; forums, and blogs with a second user from a second social website selected from the group consisting of networking sites, media sharing sites; forums, and blogs which is different than the first social media website.

7. The method of claim 1, wherein the method comprises matching the first user profile and the second user profile to a single person based on information which is common to both the first user profile and the second user profile.

8. The method of claim 1, wherein the method comprises combining information associated with the first user profile and information associated with the second user profile to create more detailed information about a person.

9. The method of claim 8, wherein the information associated with the first user profile is selected from the group consisting of behavioral information, media, biographical information, hobbies, and ideological information, and wherein the information associated with the second user profile is selected from the group consisting of behavioral information, media, biographical information, hobbies, and ideological information and is a different type of information than the information associated with the first user profile.

10. The method of claim 8, wherein the method further comprises associating the combined information with a third user account which is different from the first user profile and the second user profile.

11. The method of claim 8, further comprising:
creating an advertisement specific to the combined information; and
delivering the advertisement to the person.

12. The method of claim 8, further comprising:
preparing an advertisement;
associating characteristics about a target advertisement audience with the advertisement;
analyzing the combined information; and
delivering the advertisement to the person if the characteristics match information about the person.

13. The method of claim 8, wherein the method further comprises adding the combined information into an application form for the person.

14. The method of claim 1, wherein the method further comprises:
creating a first social graph from data associated with the first user profile;
creating a second social graph from data associated with the second user profile; and
comparing the first social graph and the second social graph.

15. The method of claim 14, wherein the method further comprises matching the first user to an unknown node in the second social graph.

16. The method of claim 14, wherein the method further comprises combining the first social graph and the second social graph to create a larger social graph associated with the person.

17. The method of claim 14, wherein the method further comprises assigning weight to connections in the first social graph based on interactions on the first social media website between the first user and other persons in the social graph.

18. The method of claim 14, wherein the method further comprises identifying connections in the first social graph based on familial relationships of the first user which are identified in the first social media website.

19. The method of claim 14, wherein the method further comprises identifying a person who is present on the first social graph and who is not present on the second social graph, and inviting that person to join the second social

20. The method of claim 1, wherein the method further comprises matching the first user profile and the second user profile to a single person by identifying similar information which was added to the first social media website and the second social media website at similar times.

21. The method of claim 1, wherein the method further comprises matching the first user profile and the second user profile to a single person by identifying commonalities between internet links associated with the first user profile and internet links associated with the second user profile.

22. The method of claim 1, wherein the method further comprises matching the first user profile and the second user profile to a single person by identifying a change in residence associated with the first user profile and a similar change in residence associated with the second user profile.
